(19) United States
(12) Patent Application Publication
(10) Pub. No.: US 2010/0046029 A1
(43) Pub. Date: Feb. 25, 2010

(54) DOCUMENT MANAGEMENT SYSTEM

(76) Inventors: Takeshi Suzuki, Kanagawa (JP); Kaoru Maeda, Kanagawa (JP); Harald Holz, Kaiserslautem (DE); Oleg Rostanin, Kaiserslautem (DE)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/542,317

(22) Filed: Aug. 17, 2009

(30) Foreign Application Priority Data
Aug. 20, 2008 (JP) 2008-212174
Jul. 30, 2009 (JP) 2009-178174

(51) Int. Cl. G06F 3/12

(52) U.S. Cl. 358/1.15

(57) ABSTRACT

A document management system includes an image input unit for reading a paper document, an image output unit for printing document image information, and a task management system for managing a task. The task managed by the task management system is identified for a document image input operation, and an input condition that is set in advance for the identified task is acquired. The image input unit reads the paper document in accordance with the acquired input condition. Document image information that is inputted by the image input unit is registered in association with the task managed by the task management system. For a document image output operation, an output condition that is set in advance for the identified task is acquired. The image output unit prints the document image information in accordance with the acquired output condition.

### BACKGROUND OF THE INVENTION

1. Field of the Invention

The present invention relates to a document management system for managing paper document information in digitized form.

2. Description of the Related Art

Conventionally, when digitizing paper document information in a document management system (DMS) based on an image apparatus, such as a multifunction peripheral (MFP), it is necessary to manually designate a storage location for the digitized document image information. Although methods are available for designating such a storage location automatically or semi-automatically, these methods merely involve registering storage locations that have been designated in the past and reusing them. In situations where a storage location needs to be dynamically changed, a setting has to be entered manually in most cases.

Against this background, the present inventors formerly introduced the concept of “task” in a document management system in order to simplify the designation of a storage location for document image information (see Japanese Laid-Open Patent Application No. 2006-243830, for example). In this system, in view of the fact that paper documents are usually digitized for storage as part of some business task, a corresponding task is identified by watermark information or the like embedded in a paper document, and document image information is stored in association with the task. Thus, the system eliminates the need for designating a storage location individually.

While such storing of document image information in association with a corresponding task eliminates the need for designating a storage location individually, digitization of a paper document also involves making various settings concerning a resolution, a color/monochrome designation, and the presence or absence of an OCR (optical character reader), as well as storage location. Although some of the modern scanners are capable of automatically determining an optimized setting based on input image information, such automatic determination does not take into consideration how the scanned image is used, i.e., the purpose of the document image information. As a result, a problem may arise when a user is about to actually use a scanned image that has been scanned with an automatically determined setting. For example, if a document that needs to be scanned at a certain resolution for business reasons is scanned at a different resolution, the scanned image may turn out to be unusable in an actual situation because of the failure to satisfy the required resolution.

Further, output of such document image information requires similar various settings, and making such settings in the light of individual business requirements is complex and time-consuming.

### SUMMARY OF THE INVENTION

It is a general object of the present invention to provide document management system in which one or more of the aforementioned problems of the related art are eliminated.

A more specific object of the present invention is to provide a document management system in which document image information input and output operations are performed in accordance with various settings or restrictions that are determined by a correspond task.

According to one aspect of the present invention, a document management system includes an image input unit configured to read a paper document; an image output unit configured to print document image information; a task management system configured to manage a task; a unit configured to identify the task managed by the task management system for a document image input operation; a unit configured to acquire an input condition that is set in advance for the identified task; a unit configured to cause the image input unit to read the paper document in accordance with the acquired input condition in the document image input operation, and configured to register document image information that is inputted by the image input unit in the document image input operation, in association with the task managed by the task management system; a unit configured to identify the task managed by the task management system for a document image output operation; a unit configured to acquire an output condition that is set in advance for the identified task; and a unit configured to cause the image output unit to print the document image information in accordance with the acquired output condition.

According to another aspect, a method of controlling a document management system including an image input unit configured to read a paper document, an image output unit configured to print document image information, and a task management system configured to manage a task includes the steps of identifying the task managed by the task management system for a document image input operation; acquiring an input condition that is set in advance for the identified task; causing the image input unit to read the paper document in accordance with the acquired input condition; registering document image information that is inputted by the image input unit in the document image input operation, in association with the task managed by the task management system; identifying the task managed by the task management system for a document image output operation; acquiring an output condition that is set in advance for the identified task; and causing the image output device to print the document image information in accordance with the acquired output condition.

According to another aspect, a computer-readable program, when executed by one or more processors, causes the one or more processors to perform the steps of the above method of controlling a document management system.

### BRIEF DESCRIPTION OF THE DRAWINGS

Other objects, features and advantages of the present invention will become apparent upon consideration of the specification and the appendant drawings, in which:

FIG. 1 shows a system according to an embodiment of the present invention;

FIG. 2 shows an implementation of a task management system according to an embodiment of the present invention;

FIG. 3A shows a hardware structure of system elements;

FIG. 3B shows a hardware structure of the image apparatus in the system shown in FIG. 1;

FIG. 4 shows an example of task information;

FIG. 5 shows a relationship between a workflow and tasks;

FIG. 6 shows a first example of an image input process according to an embodiment of the present invention;

FIG. 7 shows a second example of an image input process according to an embodiment of the present invention;

FIG. 8 shows a first example of an image output process according to an embodiment of the present invention; and

FIG. 9 shows a second example of an image output process according to an embodiment of the present invention.

### DETAILED DESCRIPTION OF THE PREFERRED EMBODIMENTS

In the following, preferred embodiments of the present invention are described with reference to the drawings, in which like reference numerals designate identical or corresponding parts throughout the several views.

### Structure

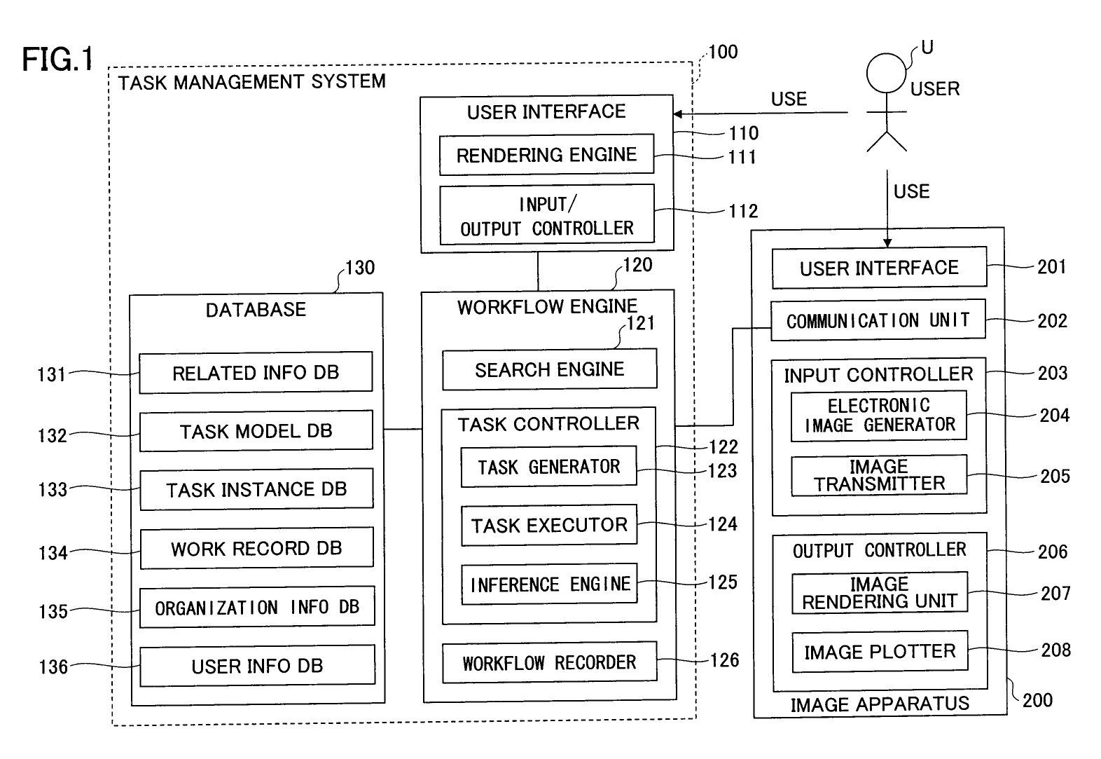

FIG. 1 shows a block diagram of a system according to an embodiment of the present invention. The system includes a task management system 100 and an image apparatus 200, which may include an MFP, both of which are used by a user U. The task management system 100 includes a user interface 110, a workflow engine 120, and a database 130. The interface 110 may include a Web browser operated on a personal computer (PC) by the user U. The workflow engine 120 may be operated on an application server. The database 130 may be operated on a database server.

The user interface 110 includes a rendering engine 111 for image rendering, and an input/output control unit 112 for controlling the input and output of data to and from the workflow engine 120. The database 130 includes a related information DB 131 for storing related information that is referenced upon execution of a workflow; a task model DB 132 for storing a task model that is abstracted in advance by an administrator or the like; a task instance DB 133 for storing task instances corresponding to specific tasks; a work record DB 134 for storing a work record of a workflow; an organization information DB 135 for storing organization information; and a user information DB 136 for storing user information (including user ID and password). The task model DB 132 and the task instance DB 133 have links to information registered in the related information DB 131, the organization information DB 135, and the user information DB 136.

The workflow engine 120 includes a search engine 121 for executing various searches on the database 130; a task control unit 122 for controlling tasks constituting a workflow; and a workflow recording unit 126 for making a work record concerning a workflow in the work record DB 134. The task control unit 122 includes a task creating unit 123 for creating a task; a task executing unit 124 for executing a created task; and an inference engine 125 for inferring a current task of the user U based on information in the work record DB 134, retrieving related information from the database 130, and presenting it.

The image apparatus 200 includes a user interface 201 for receiving an instruction from the user U via an operation panel or the like; a communication unit 202 for communication with the workflow engine 120; an input control unit 203 for reading a paper document using a scanner function; and an output control unit 206 for printing data using a printer function. The input control unit 203 includes an electronic image generating unit 204 for generating an electronic image by scanning; and an image transmission unit 205 for transmitting a generated image to a predetermined module or device. The output control unit 206 includes an image rendering unit 207 for developing a print image; and an image plotter unit 208 for printing the developed print image on a sheet of a recording material.

In a basic workflow control operation, the user U may operate the workflow engine 120 via the user interface 110 to create and execute a workflow; create a workflow model; register related information or documents; and link the related information and document with a workflow instance or a workflow model. When creating a workflow, various searches are conducted on the database 130 by the search engine 121 of the workflow engine 120.

The task control unit 122, using the task model DB 132 and the task instance DB 133, controls a task based on an instruction or the like from the user U. The task creating unit 123 of the task control unit 122 may create a task and link relevant information based on the information in the database 130, in accordance with an instruction from the user U. The task executing unit 124 utilizes the information in the task instance DB 133 in accordance with an instruction from the user U, and updates actual task information (execution of a task, when viewed from the system end, is updating of task information). The inference engine 125 infers a current task of the user U based on the information in the work record DB 134, retrieves related information from the database 130, and presents it to the user U. The workflow recording unit 126 monitors user operations and an operation of the workflow engine 120, and stores a work record of a workflow in the work record DB 134.

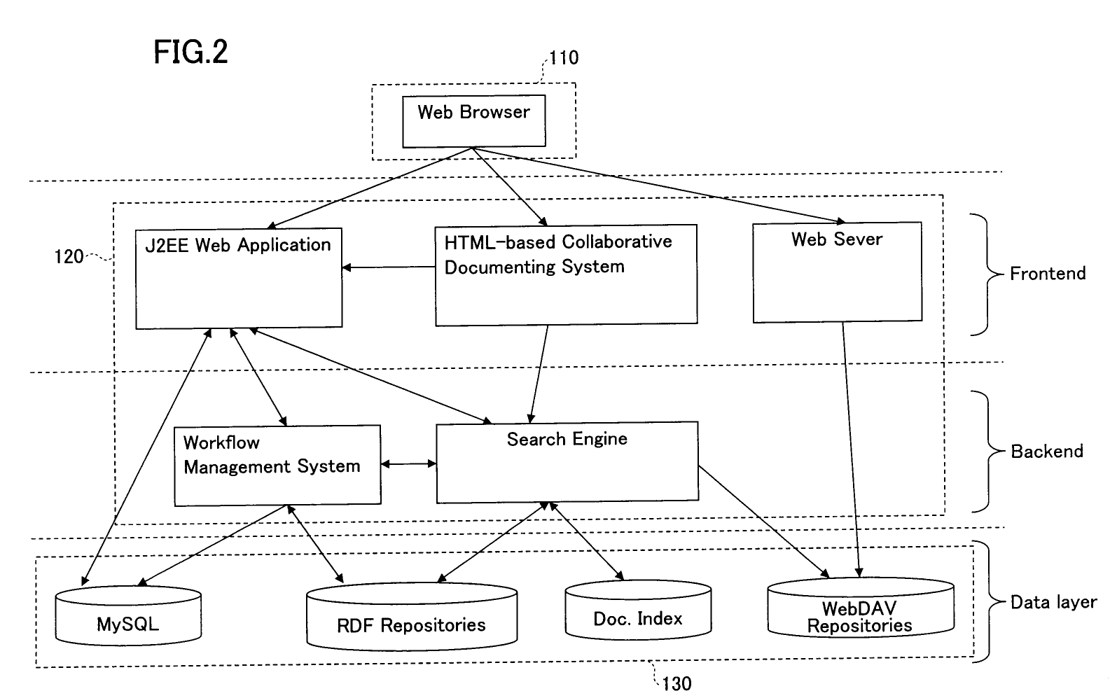

FIG. 2 shows an implementation of the task management system 100. In the task management system 100, a Web browser corresponds to the user interface 110. A J2EE (Java™ 2 Platform, Enterprise Edition) Web application, an HTML-based collaborative documenting system, a Web server, a workflow management system, and a search engine together correspond to the workflow engine 120. The J2EE Web application, the HTML-based collaborative documenting system, and the Web server constitute a frontend. The J2EE Web application is a Java™ application for controlling an application logic. The HTML-based collaborative documenting system may include a wiki. The Web server and the HTML-based collaborative documenting system enable the user U to access the system using the Web browser. A function for managing access to files on a network may be realized by using a network file management system, such as NetDrive™.

The workflow management system and the search engine constitute a backend. The basic functions for workflow management are the same as in conventional systems, so that a general workflow management system engine may be used in the system according to the present embodiment of the invention. Also, for a search for a task or related information, a general query-based search engine may be used.

The system further includes MySQL, RDF (resource description framework) repositories, Doc.Index, and WebDAV repositories, which together correspond to the database 130 and constitute a data layer. Task information and related information are managed by the RDF repositories. The related information is managed by a document repository and an index server. The former corresponds to the task model DB 132 and the task instance DB 133, while the latter corresponds to the related information DB 131. Organization information and user information are also realized by the RDF repositories, corresponding to the organization information DB 135 and the user information DB 136.

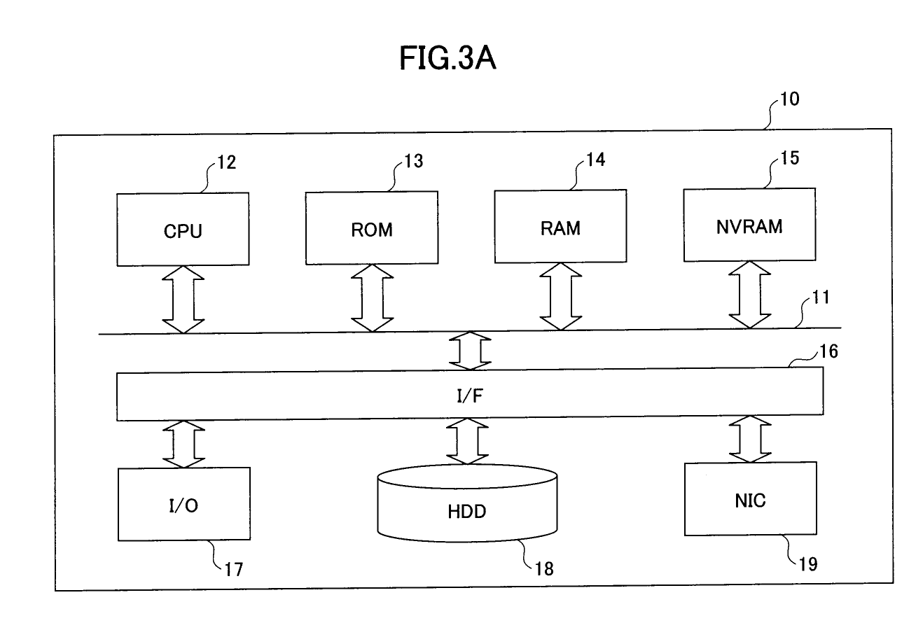

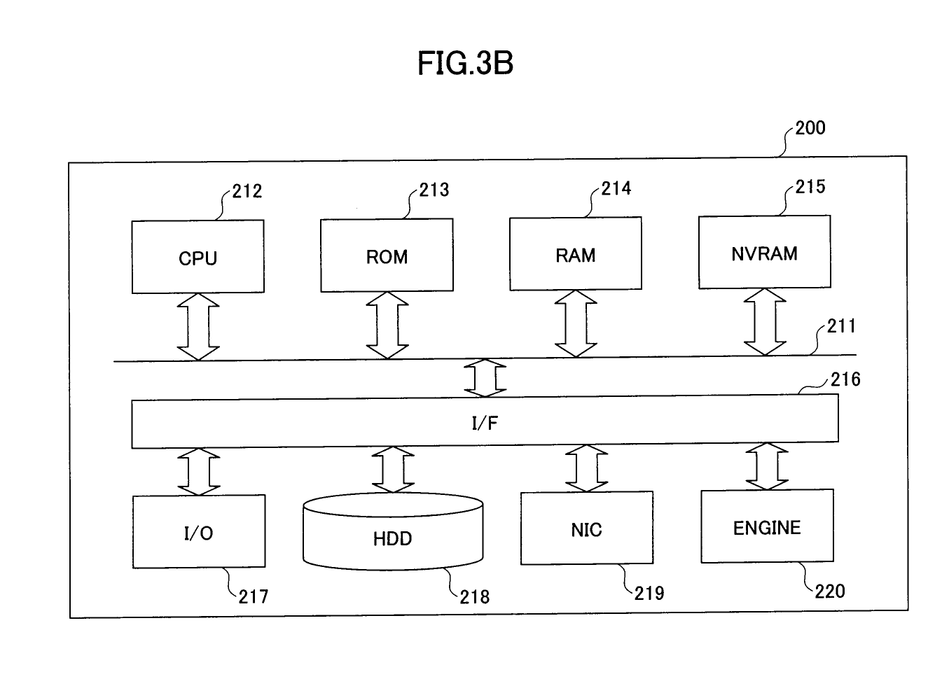

FIGS. 3A and 3B show hardware structures of the system elements. FIG. 3A shows a hardware structure of a computer apparatus 10 that may comprise the PC on which the user interface 110 is operated, the application server on which the workflow engine 120 is operated, or the database server on which the database 130 is operated. Specifically, the computer apparatus 10 includes a central processing unit (CPU) 12, a read only memory (ROM) 13, a random access memory (RAM) 14, and a non-volatile random access memory (NVRAM) 15, which are connected to a system bus 11. The computer apparatus 10 further includes an input/output (I/O) unit 17, a hard disk drive (HDD) 18, and a network interface card (NIC) 19, which are connected to an interface (I/F) 16. The I/O unit 17 may include a keyboard, a mouse, and a monitor.

FIG. 3B shows a hardware structure of the image apparatus 200. The image apparatus 200 in this hardware structure includes a CPU 212, a ROM 213, a RAM 214, and a NVRAM 215, which are connected to a system bus 211. The image apparatus 200 further includes an I/O unit 217, a HDD 218, a NIC 219, and an engine 220, which are connected to an I/F 216. The I/O unit 217 may include buttons, a touch panel, or a liquid crystal panel. The engine 220 may include a scanner mechanism and/or a printer mechanism.

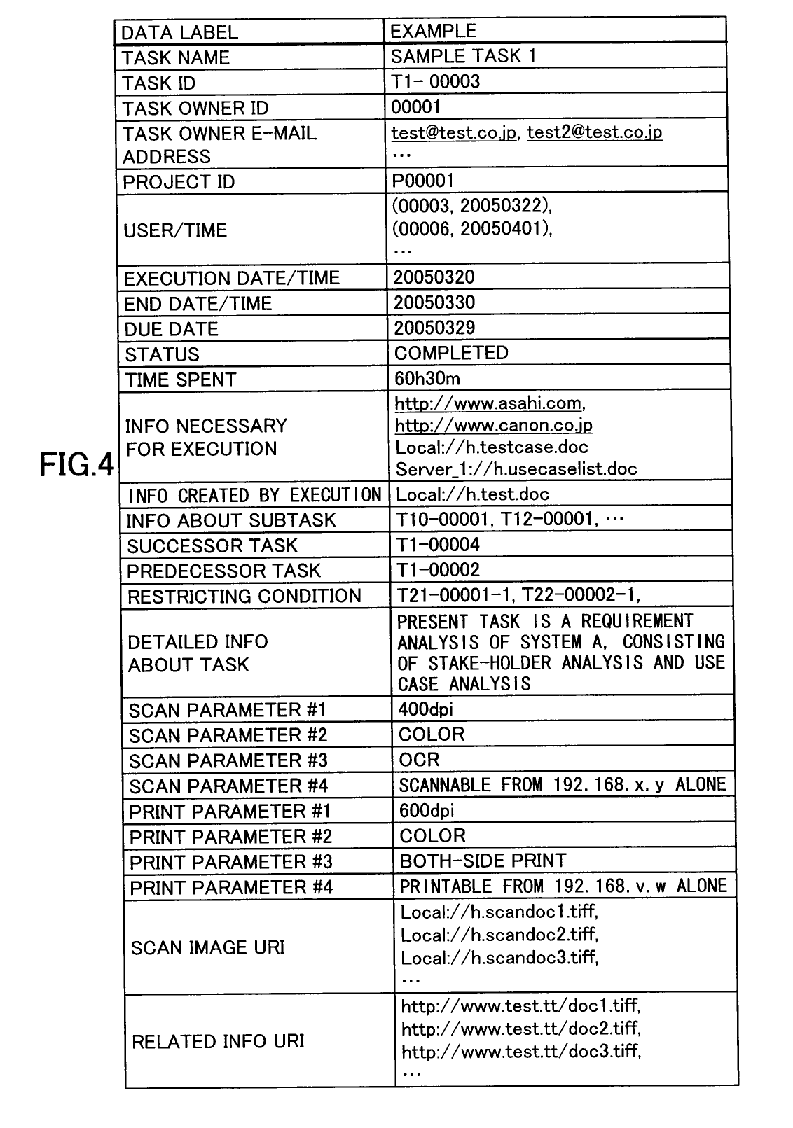

FIG. 4 shows an example of the task information stored in the task instance DB 133 on a task by task basis. As shown, the task information includes various data items (data labels), such as “task name”, “task ID”, “user ID”, “user e-mail address”, “project ID”, “user and time”, “executed date/time”, “end date/time”, “due date”, “status”, “time spent”, “required information”, “created information”, “sub-task information”, “successor task”, “predecessor task”, “restricting condition”, “detailed task information”, “scan parameters #1 to #4”, “print parameters #1 to #4”, and “scanned image URI (Uniform Resource Identifier)”.

Among those task information items, the items “scan parameters #1 to #4”, “print parameters #1 to #4”, “scanned image URI”, and “related information URI” characterize the present embodiment. The scan parameters #1 to #4 define input conditions (reading condition, restricting condition, etc.) for an image input for a particular task. In the present example, the scan parameter #1 indicates the resolution of 400 dpi; the scan parameter #2 indicates “Color” concerning the color/monochrome designation; the scan parameter #3 indicates an additional process “OCR”; and the scan parameter #4 indicates the restriction “Scannable only from 192.168.x.y” concerning the image apparatus 200 via which image input may be made. While the scan parameter #4 designates an IP address, other methods of identifying a device may be used.

The print parameters #1 to #4 define output conditions for producing (printing) an image output of a particular task. In the illustrated example, the print parameter #1 indicates the resolution of 600 dpi; the print parameter #2 indicates “Color” as to whether color or monochrome; the print parameter #3 indicates “Both-side print” as an additional process; and the print parameter #4 indicates the restriction “Printable only from 192.168.v.w.” thus limiting the image apparatus 200 for image output. While the print parameter #4 designates an IP address, other methods of identifying a device may be used.

The “scanned image URI” indicates the URI of a scanned image stored location. The “related information URI” indicates the URI of an input image stored as related information.

In the following, “task” and “workflow” are described. A task describes a user's job and has the data structure shown in FIG. 4, for example. A task is a constituent element of a workflow, and each workflow may include one or more predecessor tasks (which are executed earlier) and successor tasks (which are executed later). In other words, a workflow relates tasks in a predecessor-successor relationship.

The tasks have a hierarchical structure and may include a super-task and a subtask. For simplicity's sake, it is assumed that a task is recursively divided. Namely, each task can have only one super-task and a plurality of subtasks. According to this definition, the hierarchical structure of the tasks is of a tree shape. The preceding-succeeding relationship of tasks and their hierarchical structure do not contradict each other; rather, they complement each other.

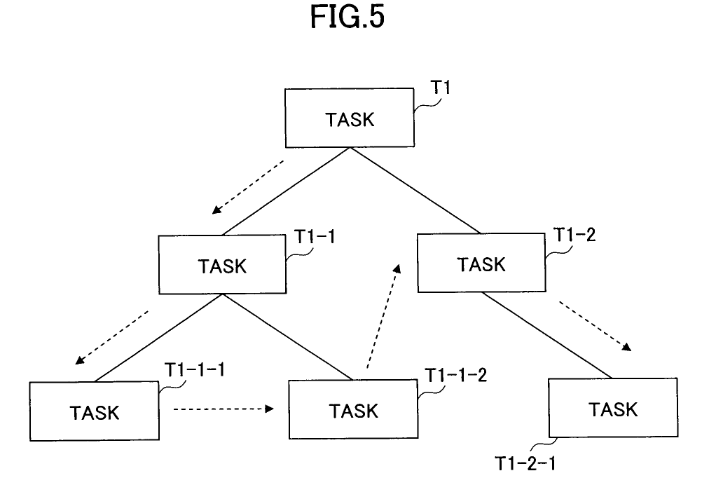

FIG. 5 shows a relationship between tasks and a workflow. In FIG. 5, the solid lines represent the hierarchical structure of the tasks, while the broken line arrows represent the predecessor-successor relationship. When the division of the tasks is complete (i.e., if the sum of the subtasks is a super-task), executing task T1 is equivalent to executing tasks T1-1 and T1-2. Each of the tasks T1-1 and T1-2 is further subdivided; the former is equivalent to executing both tasks T1-1-1 and T1-1-2, and the latter is equivalent to executing task T1-2-1. Thus, executing task T1 is eventually equivalent to executing tasks T1-1-1, T1-1-2, and T1-2-1.

When the division of the tasks is not complete (i.e., when the sum of the subtasks is not a super-task), the super-task includes its own content in addition to the sum of the subtasks, so that the order of execution of the tasks is different from that of the preceding case. If the content of the super-task is executed earlier than the subtasks, executing task T1 is equivalent to executing tasks T1, T1-1, T1-1-1, T1-1-2, T1-2, and T1-2-1 in order.

Thus, whether the division of the tasks is complete or incomplete, the order of execution of the tasks, i.e., a workflow, can be defined by utilizing the recursive division of the tasks (i.e., the tasks' tree structure). The order of execution of the tasks does not necessarily have to be as described above, and may be set independently of the hierarchical structure.

### Operation

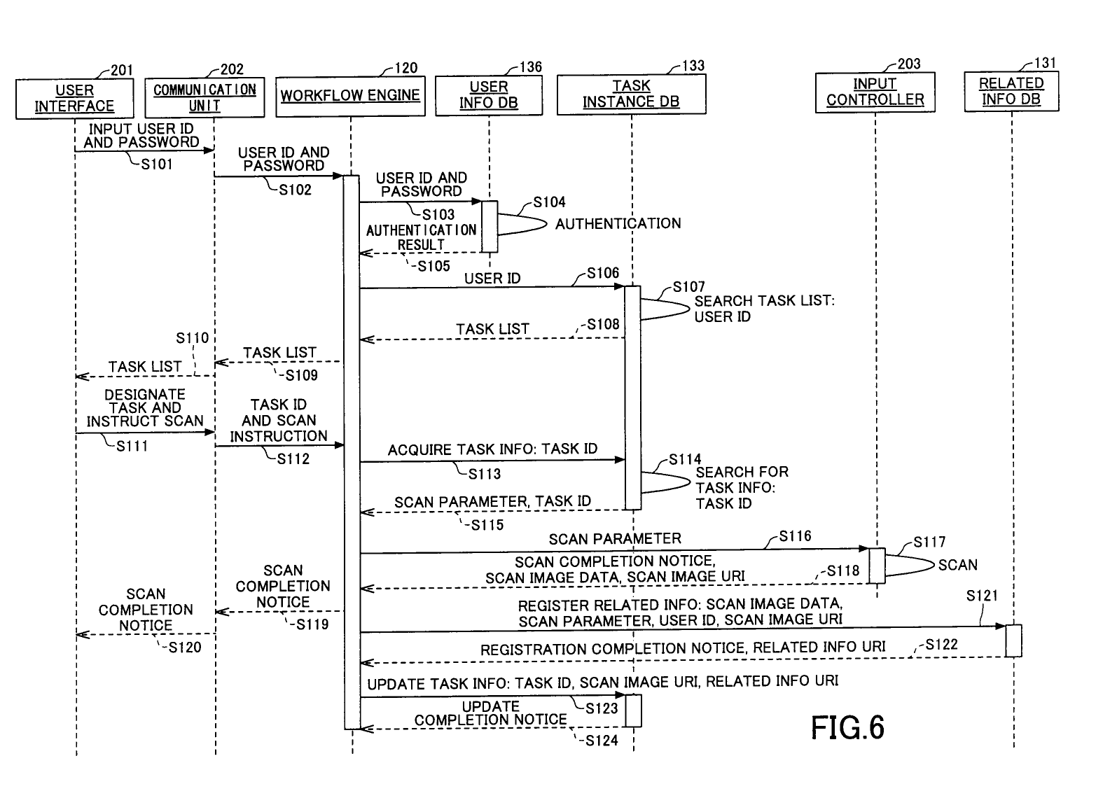

FIG. 6 shows an image input process according to an embodiment of the present invention. The user U enters a user ID and a password via the user interface 201 of the image apparatus 200 for authentication. The user ID and the password are transmitted to the communication unit 202 (step S101). From the communication unit 202, the user ID and the password are further transmitted to the workflow engine 120 (step S102).

The workflow engine 120 searches the user information DB 136 for the entered user ID and password, using the search engine 121 (steps S103 and S104), for authentication, and obtains an authentication result (step S105). It is now assumed that the user has been correctly authenticated.

Then, the workflow engine 120, based on the authenticated user ID, searches the task instance DB 133 using the search engine 121 (steps S106 and S107), and obtains a list of tasks associated with the user ID (step S108). The acquired task list is transmitted from the workflow engine 120 via the communication unit 202 to the user interface 201 (steps S109 and S110), and displayed on the operation panel or the like.

The user U then designates a desired task (to which a digitized document is to be attached) from the displayed task list and enters a scan instruction. The task designation and the scan instruction are transmitted from the user interface 201 to the communication unit 202 (step S111), from which the task ID and the scan instruction are further transmitted to the workflow engine 120 (step S112).

Based on the task ID, the workflow engine 120 searches the task instance DB 133, using the search engine 121 (steps S113 and S114), and obtains a scan parameter (step S115). The scan parameter is then transmitted from the workflow engine 120 to the input control unit 203 of the image apparatus 200, together with a scan instruction (step S116). Alternatively, the workflow engine 120 may transmit the acquired scan parameter via the communication unit 202 to the user interface 201, prompt the user U to confirm or modify the scan parameter, and then send a scan instruction to the input control unit 203.

In response to the scan instruction from the workflow engine 120, the input control unit 203 scans a certain image in accordance with the given scan parameter, stores scanned image data at a predetermined URI (scanned image URI)(step S117), and transmits a scan completion notice, the scanned image data, and the scanned image URI to the workflow engine 120 (step S118). The workflow engine 120 then transmits the scan completion notice via the communication unit 202 to the user interface 201 (steps S119 and S120), so that a scan completion message or the like can be displayed on the operation panel or the like.

The workflow engine 120 also registers the scanned image data, the scan parameter, the user ID, the scanned image URI and the like in the related information DB 131 as related information (step S121), and then receives a registration completion notice and a related information URI (step S122).

When the scanned image data is registered in the related information DB 131 as related information, task information such as the task ID may be embedded as a header or metadata of the scanned image data. For example, the Exchangeable Image File Format (Exif), which is a standard digital camera file format, provides a tag allowing a user to add a comment. By utilizing this tag, the task ID of a task to which a document is attached can be retained as image information. In the case of Exif SubIFD (Image File Directory), such a comment can be written on the UserComment tag (Tag ID 37510). This tag does not specify data type and is suitable for storing a scanned-document-identifying ID. Other than these, Exif provides an ImageDescription tag (Tag ID 270), for example, which enables the storage of an ASCII (American Standard Code for Information) character string. Because URL (Uniform Resource Locator) and URI are normally expressed as an ASCII-format character string, this tag can be used for saving a scanned-document-identifying ID. It is also possible to directly write a comment as metadata in TIFF (Tagged Image File Format), without using Exif. The TIFF specification permits various tags, including a number of optional tags besides essential tags. For example, the image description tag (tag ID 270) permits the storage of an ASCII-format character string (where a pointer to the character string is stored in the same tag), enabling the storage of the aforementioned URI and the like.

Thus, by embedding the task information in the scanned image data, a corresponding task can be identified from the related information. Instead of registering the scanned image data per se, the URI of the scanned image may be registered in the related information. In this case, accumulation of overlapping image data in the system as a whole can be prevented, so that the disk capacity and the like can be saved.

Thereafter, the workflow engine 120, designating a task ID, causes the task instance DB 133 to register the scanned image URI and the related information URI in order to update the task information in the task instance DB 133 (step S123). The workflow engine 120 then receives an update completion notice (step S124).

Thus, image input is automatically performed in accordance with the scan parameter defined in the task with which the image is to be associated, so that the image input can be performed with an appropriate setting adapted to the nature or contents of operation.

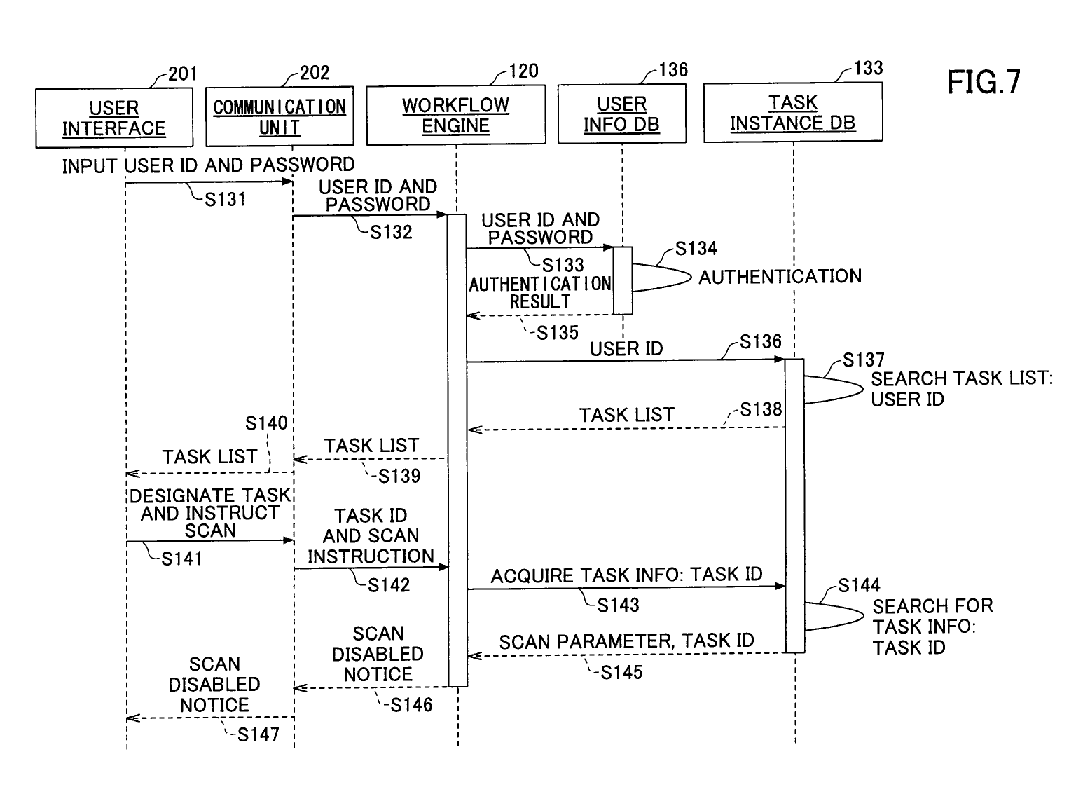

FIG. 7 shows another example of an image input process according to an embodiment of the present invention. This example assumes a case where image input is rejected due to a restriction concerning the image apparatus 200 for performing an image input operation. The image input process shown in FIG. 7 may be suitably applied for certain types of operation, such as the scanning of a ledger sheet, where input from scanners other than a specific scanner is not permitted.

Referring to FIG. 7, upon entry of a user ID and a password by the user U via the user interface 201 of the image apparatus 200 for authentication, the user ID and the password are transmitted from the user interface 201 to the communication unit 202 (step S131). The user ID and the password are further transmitted from the communication unit 202 to the workflow engine 120 (step S132).

The workflow engine 120 then searches the user information DB 136, using the search engine 121, for the user ID and the password (steps S133 and S134), obtaining an authentication result (step S135). It is herein assumed that the user has been correctly authenticated. The workflow engine 120 then searches the task instance DB 133, using the search engine 121, based on the authenticated user ID (steps S136 and S137), and acquires a list of tasks associated with the user ID (step S138). The acquired task list is transmitted from the workflow engine 120 via the communication unit 202 to the user interface 201 (steps S139 and S140), and the task list is displayed on the operation panel or the like.

The user U designates a desired task (to which a digitized document is to be attached) in the task list displayed on the operation panel or the like, and enters a scan instruction. The task designation and the scan instruction are transmitted from the user interface 201 to the communication unit 202 (step S141) from which the task ID and the scan instruction are further transmitted to the workflow engine 120 (step S142).

Based on the task ID, the workflow engine 120 searches the task instance DB 133, using the search engine 121 (steps S143 and S144), and acquires a scan parameter (step S145). If there is a restriction in the scan parameter concerning the image apparatus (such as the scan parameter #4 shown in FIG. 4), the workflow engine 120 compares the restricting condition with the IP address, for example, associated with the communicated data from the communication unit 202. If the current image apparatus is not the image apparatus with the permitted IP address, a scan disabled notice is sent via the communication unit 202 to the user interface 201 (steps S146 and S147), and a message or the like indicating that the scan is disabled is displayed on the operation panel or the like.

Thus, by restricting the image apparatus in terms of an input condition, image input from an image apparatus that is not permitted can be prohibited, thereby enabling allocation of different roles to different image apparatuses, or control of the image apparatuses from security aspects, for example.

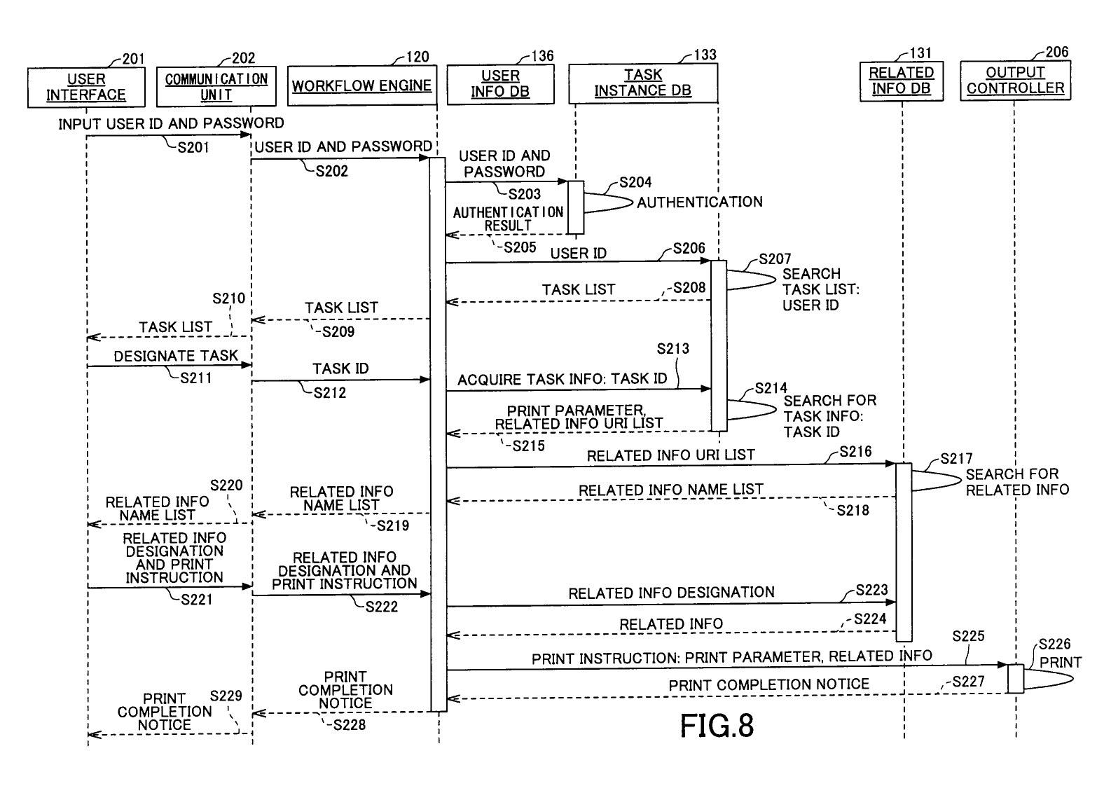

FIG. 8 shows an image output process according to an embodiment of the present invention. Upon entry of a user ID and a password from the user U via the user interface 201 of the image apparatus 200 for authentication, the user ID and the password are transmitted from the user interface 201 to the communication unit 202 (step S201). The user ID and the password are further transmitted from the communication unit 202 to the workflow engine 120 (step S202).

The workflow engine 120 then searches the user information DB 136, using the search engine 121, for the user ID and the password (steps S203 and S204), and obtains an authentication result (step S205). It is herein assumed that the user U has been correctly authenticated.

Then, the workflow engine 120 searches the task instance DB 133, using the search engine 121, based on the authenticated user ID (steps S206 and S207), and obtains a list of tasks associated with the user ID (step S208). The obtained task list is transmitted from the workflow engine 120 via the communication unit 202 to the user interface 201 (steps S209 and S210), so that the task list can be displayed on the operation panel or the like.

The user U designates a desired task from the task list displayed on the operation panel or the like, and then the task designation is transmitted from the user interface 201 to the communication unit 202 (step S211). A corresponding task ID is then transmitted from the communication unit 202 to the workflow engine 120 (step S212). When it is unclear with which task a related document is associated, a search for the related document may be performed using a general search function.

Based on the task ID, the workflow engine 120 searches the task instance DB 133, using the search engine 121 (steps S213 and S214), and obtains a print parameter and a list of related information URIs (step S215).

Then, the workflow engine 120, based on the related information URI list, searches the related information DB 131 using the search engine 121 (steps S216 and S217), and obtains a list of names of related information (step S218). The names of the related information are managed in the related information DB 131.

The workflow engine 120 transmits the related information name list via the communication unit 202 to the user interface 201 (steps S219 and S220), so that the related information name list can be displayed on the operation panel or the like.

The user U then designates desired related information from the related information name list displayed on the operation panel or the like and enters a print instruction. The related information designation and the print instruction are then transmitted from the user interface 201 to the communication unit 202 (step S221), from which the related information designation and the print instruction are further transmitted to the workflow engine 120 (step S222). The workflow engine 120 then acquires the related information from the related information DB 131 by designating the related information (steps S223 and S224).

The workflow engine 120 then sends a print instruction to the output control unit 206 while designating the print parameter and the related information (step S226). In response, the output control unit 206 performs printing in accordance with the print parameter (step S226), and transmits a print completion notice to the workflow engine 120 (step S227). The workflow engine 120 transmits the print completion notice via the communication unit 202 to the user interface 201 (steps S228 and S229), so that a message or the like can be displayed on the operation panel or the like indicating the completion of the printing operation.

Thus, image output is automatically performed in accordance with the print parameter defined in the task associated with the related document to be printed, so that the image output can be performed with an appropriate setting adapted to the nature or contents of the operation.

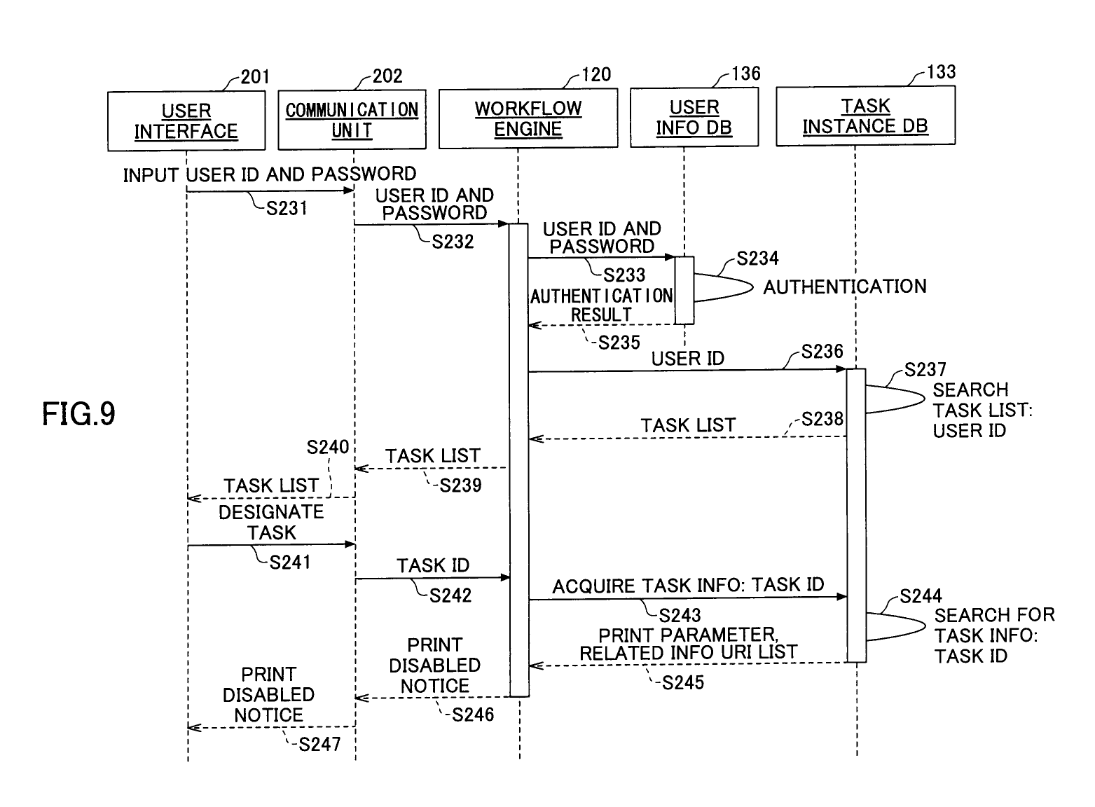

FIG. 9 shows another example of an image output process according to an embodiment of the present invention. This example assumes a case where image output is rejected due to a restriction concerning the image apparatus 200 for image output. In the case of highly classified information and the like, printout control is an important issue. For example, paper output should desirably be prohibited other than via a specific printer.

Referring to FIG. 9, upon entry of a user ID and a password by the user U via the user interface 201 of the image apparatus 200 for authentication, the user ID and the password are transmitted from the user interface 201 to the communication unit 202 (step S231). From the communication unit 202, the user ID and the password are further transmitted to the workflow engine 120 (step S232).

The workflow engine 120 then searches the user information DB 136, using the search engine 121, for the user ID and the password (steps S233 and S234) for authentication, and obtains an authentication result (step S235). It is herein assumed that the user U has been correctly authenticated.

Then, the workflow engine 120, based on the authenticated user ID, searches the task instance DB 133 using the search engine 121 (steps S236 and S237), and acquires a list of tasks associated with the user ID (step S238). The acquired task list is transmitted from the workflow engine 120 via the communication unit 202 to the user interface 201 (steps S239 and S240), so that the task list can be displayed on the operation panel or the like.

The user U then designates a desired task from the task list displayed on the operation panel or the like. The task designation is transmitted from the user interface 201 to the communication unit 202 (step S241), and a corresponding task ID is transmitted from the communication unit 202 to the workflow engine 120 (step S242).

The workflow engine 120, based on the task ID, searches the task instance DB 133 using the search engine 121 (steps S243 and S244), and acquires a print parameter and a related information URI list (step S245).

When there is a restriction in the print parameter concerning the image apparatus (such as the print parameter #4 shown in FIG. 4), the workflow engine 120 compares the restricting condition with the IP address, for example, associated with the data communicated from the communication unit 202. If the current image apparatus is not the image apparatus with the permitted IP address, a print disabled notice is sent via the communication unit 202 to the user interface 201 (steps S246 and S247), so that a message or the like can be displayed on the operation panel or the like, indicating that printing is disabled.

Thus, by restricting the image apparatus in terms of an output condition, image output from an image apparatus that is not permitted can be prohibited, thus enabling allocation of different roles to different image apparatuses or control of the image apparatuses from security aspects.

Although this invention has been described in detail with reference to certain embodiments, variations and modifications exist within the scope and spirit of the invention as described and defined in the following claims.

The present application is based on the Japanese Priority Applications No. 2008-212174 filed Aug. 20, 2008, and No. 2009-178174 filed Jul. 30, 2009, the entire contents of which are hereby incorporated by reference.

What is claimed is:

1. A document management system comprising:
an image input unit configured to read a paper document;
an image output unit configured to print document image information;
a task management system configured to manage a task;
a unit configured to identify the task managed by the task management system for a document image input operation;
a unit configured to acquire an input condition that is set in advance for the identified task;
a unit configured to cause the image input unit to read the paper document in accordance with the acquired input condition in the document image input operation, and configured to register document image information that is inputted by the image input unit in the document image input operation, in association with the task managed by the task management system;
a unit configured to identify the task managed by the task management system for a document image output operation;
a unit configured to acquire an output condition that is set in advance for the identified task; and
a unit configured to cause the image output unit to print the document image information in accordance with the acquired output condition.

2. The document management system according to claim 1, wherein the input condition includes a scan parameter defining a reading condition for the paper document.

3. The document management system according to claim 1, wherein the input condition includes information that limits the image input unit.

4. The document management system according to claim 1, wherein information identifying the task is recorded in the document image information inputted by the image input unit.

5. The document management system according to claim 1, wherein the output condition includes a print parameter that defines a print condition for the document image information.

6. The document management system according to claim 1, wherein the output condition includes information that limits the image output unit.

7. A method of controlling a document management system including an image input unit configured to read a paper document, an image output unit configured to print document image information, and a task management system configured to manage a task, the method comprising the steps of:
identifying the task managed by the task management system for a document image input operation;
acquiring an input condition that is set in advance for the identified task;
causing the image input unit to read the paper document in accordance with the acquired input condition;
registering document image information that is inputted by the image input unit in the document image input operation, in association with the task managed by the task management system;
identifying the task managed by the task management system for a document image output operation;
acquiring an output condition that is set in advance for the identified task; and
causing the image output device to print the document image information in accordance with the acquired output condition.

8. A computer-readable program for controlling a document management system having an image input unit configured to read a paper document, an image output unit configured to print document image information, and a task management system configured to manage a task,
wherein execution of the program by one or more processors causes the one or more processors to perform the steps of:
identifying the task managed by the task management system for a document image input operation;
acquiring an input condition that is set in advance for the identified task;
causing the image input unit to read the paper document in accordance with the acquired input condition;
registering document image information that is inputted by the image input unit in the document image input operation, in association with the task managed by the task management system;
identifying the task managed by the task management system for a document image output operation;
acquiring an output condition that is set in advance for the identified task; and
causing the image output device to print the document image information in accordance with the acquired output condition.
